(19) United States
(12) Patent Application Publication
(10) Pub. No.: US 2017/0032686 A1
(43) Pub. Date: Feb. 2, 2017

(54) DRONE PAD STATION AND MANAGING SET OF SUCH A DRONE PAD STATION

(71) Applicant: Airbus (SAS), Blagnac (FR)

(72) Inventors: Diego ALONSO TABARES, Toulouse (FR); Gerard DELSAUT, Toulouse (FR); Sebastien DEMAISON, Leguevin (FR)

(21) Appl. No.: 15/223,407

(22) Filed: Jul. 29, 2016

(30) Foreign Application Priority Data
Jul. 30, 2015 (FR) 1557294

(51) Int. Cl. G08G 5/02; G08G 5/00; B64C 39/02; B64F 1/02; B64F 1/36; B64D 45/04; B60L 11/18

(52) U.S. Cl. CPC G08G 5/02; B64D 45/04; G08G 5/0013; B60L 11/182; G08G 5/0091; B64F 1/02; B64F 1/362; B64C 39/024; B60L 2230/22; B64C 2201/18

(57) ABSTRACT

A drone pad includes a structure configured to be mounted on a base and provided with a platform for a drone and a wireless data transmission system. The data transmission system includes a first data transmission unit configured to communicate with at least one control center and a second data transmission unit configured to communicate with at least one drone, as well as a central unit linked to the data transmission system.

### CROSS-REFERENCE TO RELATED APPLICATION

This application claims priority to French Patent Application No. 1557294, filed Jul. 30, 2015, which is incorporated herein by reference in its entirety.

### TECHNICAL FIELD

The embodiments described herein relate to a drone pad and to a set for managing such a pad.

### BACKGROUND

It is to be expected that drones will more and more frequently be used for security checks or for detailed visual inspections in particular on sensitive and/or secure sites or of zones that are not easily accessible in the future.

Currently, drones are not legally allowed to fly over urban zones and require clearance to fly over industrial zones and controlled zones of the airspace such as airports.

In particular because of the size of the zone likely to be monitored and the distance to the control center, the management of one or more drones from a single control center is not always easy in such an environment.

### SUMMARY

The present disclosure provides a remedy the drawback discussed in the Background, and relates to a drone pad including a structure able to be mounted on a base and provided with a platform for at least one drone. According to the present disclosure, the drone pad or simply pad also includes a wireless data transmission system having at least one first data transmission unit able to communicate with at least one control center; at least one second data transmission unit able to communicate with at least one drone; and a central unit linked to the data transmission system.

Thus, by virtue of the embodiment, in addition to providing a site (via the platform) for receiving a drone, for example at the end of its mission or to allow it to recharge its batteries as necessary as specified below, the pad is able, using the data transmission system, to communicate with the control center (and the drone), which may continue to monitor and manage the mission of the drone, as also specified below.

Advantageously, the pad includes at least one data generation unit linked to the central unit and configured to generate data relating to the pad. At least some of these data may be transmitted to the control center via the data transmission system.

Moreover, advantageously, the pad may also include one or more of the following components. The pad may include at least one computing unit configured to compute at least one takeoff path or one landing path of a drone. The pad may include at least one electrical charging system able to charge a battery of a drone located on the platform for the drone. The electrical charging system may include an electrical induction plate supplied with power by an electrical battery. The electric battery is preferably supplied with power using at least one solar panel mounted on the structure. The pad may include at least one positioning unit forming part of a satellite-based positioning system. The pad may also at least one solar panel; at least one meteorological unit; at least one unit for determining a battery state of the battery(ies) of the pad; at least one bird scaring device; and/or at least one data generation unit able to generate data relating to a drone. Furthermore, advantageously, the drone platform is provided with at least one positioning indicator.

The present embodiment also relates to a managing set for managing a pad. According to the embodiment, this managing set includes at least one control center, and at least one pad such as that described above. The pad is linked via the first data transmission unit of the data transmission system to the control center, which is equipped with an interacting data transmission unit.

The present embodiment furthermore relates to a system for managing at least one drone including at least one managing set such as mentioned above, and at least one drone. In one particular embodiment, the drone is equipped with a guiding unit configured to automatically guide the drone toward a pad of the managing set. Furthermore, in another particular embodiment, the drone is equipped with an induction plate that is intended to recharge a battery and configured to interact with an induction plate of a pad of the managing set, when the drone is located on the platform of this pad.

The present embodiment also relates to a method for transmitting data using a system for managing at least one drone, such as described above. According to the embodiment, the data such as may be transmitted from the pad to the control center. Data that may be transmitted from the pad to the control center may include the state of charge of the least one battery of the pad, the availability of the pad, and/or the state of at least one piece of equipment mounted on the pad. Data may also be transmitted from the control center to the pad, which data may include at least one check request to the pad. Data may also be transmitted from the pad to a drone, which data may include at least one order to stop a motor of the drone. Data may also be transmitted from the drone to the pad.

Other advantages, desirable features and characteristics will become apparent from this summary, the preceeding background and the subsequent detailed description, and the appended claims, taken in conjunction with the accompanying drawings.

### BRIEF DESCRIPTION OF THE DRAWINGS

It will be clearly understood how the embodiment(s) may be implemented from the following drawings. The various embodiments will hereinafter be described in conjunction with the following figures, in which identical references designate similar components.

FIG. 1 schematically shows, in perspective, a drone approaching a pad according to an embodiment;

FIG. 2 schematically shows, in perspective, the pad in FIG. 1;

FIG. 3 is a block diagram of a drone management system;

FIG. 4 schematically shows, in perspective, a drain such as shown in FIG. 1;

FIG. 5 schematically shows, in perspective, a pad on which a drone is docked;

FIG. 6 schematically shows, from the side, the pad such as shown in FIG. 5 on which a drone is docked; and

FIG. 7 is a schematic representation illustrating examples of communication between a pad, a drone and a control center.

### DETAILED DESCRIPTION

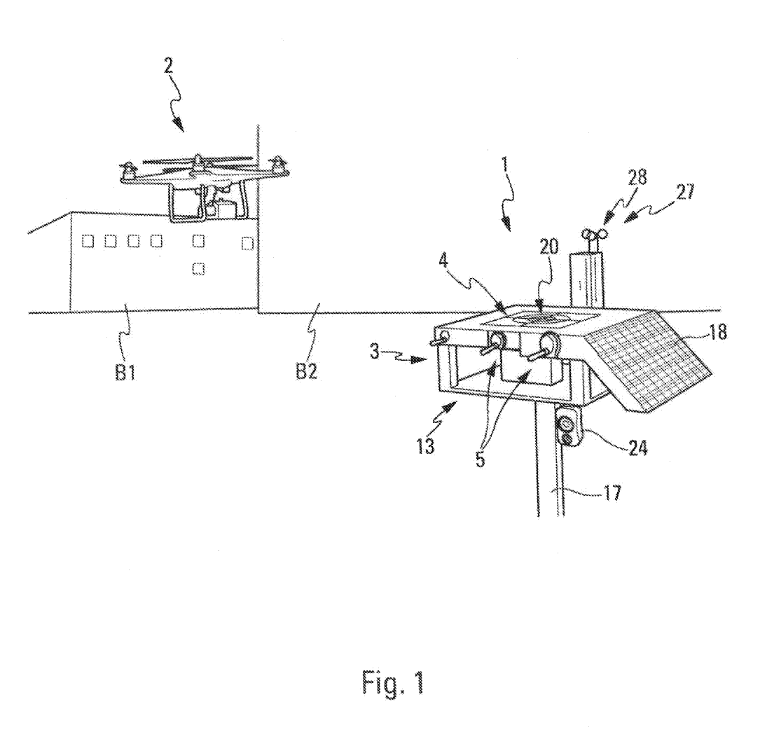

With reference now to the drawings, the pad 1 schematically shown in FIG. 1 and allowing the embodiment to be illustrated is a pad for a drone 2.

In the example in FIG. 1, the pad 1 is installed in a space, for example an industrial zone or an airport, including buildings B1 and B2.

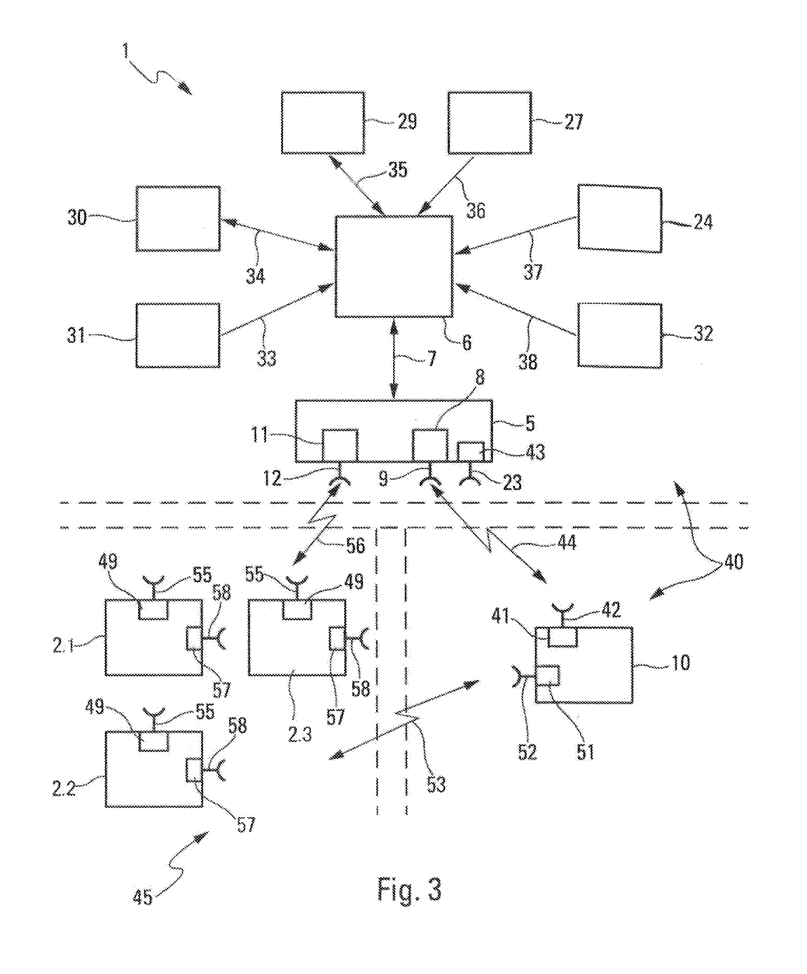

With reference now to FIGS. 1-3, according to the embodiment, the pad 1 includes, a structure 3 that is configured to be mounted on a base (not shown) and that is provided with a platform 4 (or dock) for at least one drone. The pad 1 also includes a wireless data transmission system 5 and a central unit 6 linked to the data transmission system 5 by way of a link 7, as shown in FIG. 3. In addition, according to the embodiment, the data transmission system 5 includes a data transmission unit 8 able to communicate with at least one control center 10, via an antenna 9 and a data transmission unit 11 able to communicate with at least one drone 2 via an antenna 12.

The pad 1 is equipped with the wireless data transmission system 5, which may especially automatically transmit data on the main pieces of equipment of the pad 1, as further specified below. The pad 1 is an autonomous pad, which is able to dock any type of drone, whatever the characteristics (size, weight) of the drone. This pad 1 may be installed in various locations (roof, pylon, façade) of various zones (airport, industrial site, etc.) and on various bases.

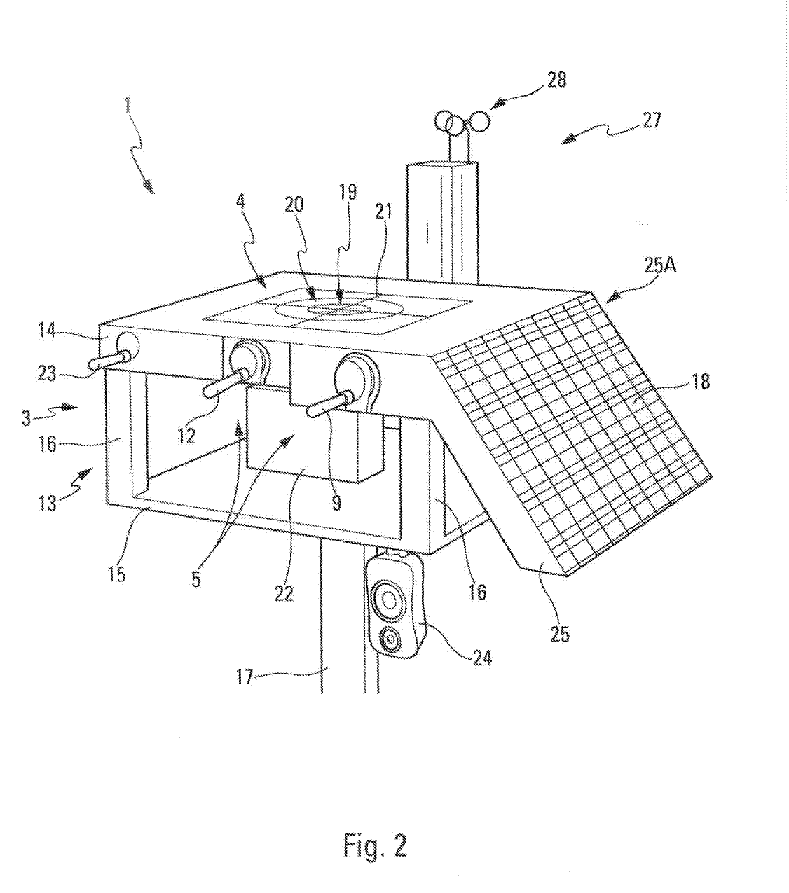

The structure 3 of the pad 1 includes a base part 13 that is for example made of metal. In the particular embodiment shown in FIG. 2, the structural part 13 includes two flat and superposed base plates 14 and 15 that are for example square or rectangular in shape. The upper plate 14 serves, on its upper side, as a platform 4 for a drone 2. The base plates 14 and 15 are securely fastened to each other by way of linking legs 16. The linking legs 16 are arranged between the base plates 14 and 15, preferably at the four corners of the base plates 14 and 15. This structural part 13 is placed (or fastened) to the ground or to another base by way of one or more legs 17, namely a single leg 17 (partially shown) in the examples in FIGS. 1 and 2.

As for example shown in FIGS. 1 and/or 2, the pad 1 may also be equipped with one or more solar panels 18, an induction plate connector 19, a positioning indicator 20, at least one battery 22 placed on the lower base plate 15, an antenna 23 of a positioning unit 43 (FIG. 3), interacting with a satellite-based positioning system such as a GPS (global positioning system), and/or a bird scaring device 24.

The positioning indicator 20 may, for example, be a marking that is produced directly on the platform 4 or that is produced on a sheet attached to the platform 4 and including a target 21 shown for example in the form of a cross.

The bird scaring device 24 may be an audio device. In one preferred embodiment, this audio device is automatically and randomly triggered, in order to prevent birds from taking up residence. This audio device may also be remotely controlled by the operator of the control center 10.

The antenna 9, 12 and 23 are preferably arranged on the side of the structure 3, as shown in FIGS. 1 and 2.

The solar panel 18 is configured to charge the battery 22, which serves to supply the electrical equipment of the pad 1 with electricity. By virtue of the solar panel(s) 18, the pad 1 is electrically autonomous, and is therefore not limited in its installation, since no electrical connection is required. The solar panel 18 is preferably arranged on a plate 25 (FIG. 2). This plate 25 is fastened by one 25A of its vertical ends, for example to the base plate 14 while being directed downward. While this plate 25 is arranged on an inclined, it may of course also be arranged horizontally.

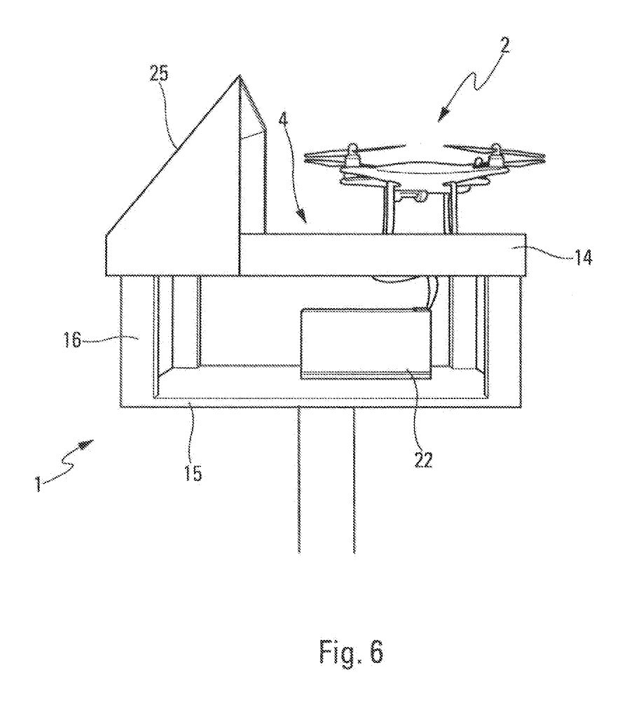

In one particular embodiment, shown in FIGS. 5 and 6, the plate 25 that bears the solar panel 18 is mounted on top of the base plate 14. It may thus form a protective component especially protecting from sight and exterior aggressions such as gusts of wind for example.

The pad 1 also includes an electrical charging system configured to charge a battery of a drone located on the drone platform. The electrical charging system includes the electrical induction plate (the connector 19 of which is visible in FIG. 2) which is supplied with power by the electrical battery 22. The electrical battery 22 itself is supplied with power using the one or more solar panels 18 of the pad 1.

The pad 1 may also include a meteorological unit (or station) 27 especially including at least one of the following components: an anemometer, a barometer, a component for measuring temperature, etc. In FIGS. 1 and 2, an anemometer 28 of the meteorological unit 27 has been shown by way of example.

As shown in FIG. 3, the pad 1 includes data generation units, which are linked to the central unit 6 and which are configured to generate data relating to the pad 1. At least one of these data are transmitted to the control center 10, via the central unit 6 and the data transmission system 5. The pad 1 preferably includes a computing unit 29 configured to automatically compute at least one takeoff path or one landing path of a drone, a unit for authenticating a drone 30 (mission control relays), and a unit 31 for determining a power status of equipment of the pad 1 such as the battery, the solar panel of the pad 1, and/or other equipment of the pad 1, and a unit 32 for determining the state of the battery of the drone 2 or other equipment associated with the drone 2. The pad 1 also preferably includes the meteorological unit 27 and the bird scaring device 24.

Data generated by the meteorological unit 27 are taken into account by the computing unit 29 when calculating the takeoff and landing paths. In particular, the direction and strength of the wind, which are determined by the anemometer 28, are taken into account to optimize the path depending on the actual exterior conditions about the pad 1.

The components 31, 30, 29, 27, 24 and 32 are respectively connected by way of links 33 to 38 to the central unit 6. The computing unit 29 may also be integrated into the central unit 6.

The pad 1 forms part of a set 40 for managing a drone pad. This managing set 40 includes at least one pad 1 such as described above and at least one control center 10, as schematically illustrated in FIG. 3. The managing set 40 includes at least one video camera allowing operators to view and monitor the pad 1 from the control center 10. This video camera may be located on one of the buildings B1 or B2 (FIG. 1) or even on a base integrated into the pad and it has an orientation allowing the platform to be viewed.

The control center 10 is preferably remote from the pad 1. The control center 10 includes a data transmission (emission/reception) unit 41 provided with an antenna 42 that interacts with the data transmission (emission/reception) unit 8 installed on the pad 1, in order to allow them to communicate together, as illustrated by a symbol 44 (representing electromagnetic waves) in FIG. 3.

This managing set 40 forms part of a system 45 for managing a drone, such as also shown in FIG. 3, which in addition includes at least one drone 2. In FIG. 3, three drones 2 located in different locations in the space surrounding the pad 1 have been shown. These drones 2.1, 2.2, 2.3, individually and collectively correspond to the drone 2 shown in the other figures.

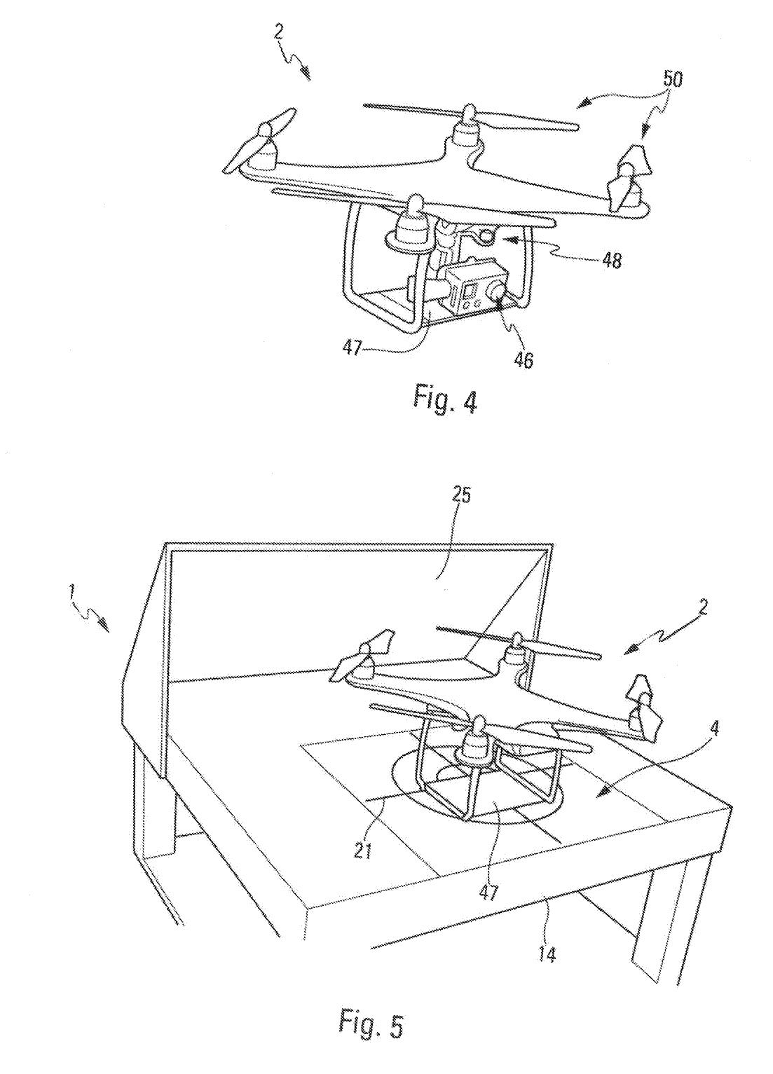

Each drone 2 is equipped, as shown for example in FIG. 4, with a set of conventional drive means especially including a motor (not shown) and propellers 50, which allow the drone 2 to fly; at least one conventional video camera 46 of any type, which is capable of taking images in the visual and/or which is capable of seeing types of light other than visible light, infrared light for example; an induction plate 47; and a positioning unit 48 interacting with a satellite-based positioning system such as a GPS (global positioning system).

The drone 2 is thus equipped with the video camera 46 which allows it to observe dangerous zones and/or zones that are difficult to access. This video camera 46 also allows the target 21 on the platform 4 of the pad 1 (FIGS. 4 and 5) to be identified in order to allow the drone 2 to position itself correctly on the pad 1 as specified below.

The drone 2 is also equipped with the induction plate 47 intended to recharge at least one on-board battery (not shown), which is intended to supply the various pieces of equipment of the drone 2 with electricity. This induction plate 47 is configured to interact with the induction plate of the pad 1, when the drone 2 is located on the platform 4 of this pad 1, as for example illustrated in FIGS. 5 and 6.

The managing system 45 thus includes an electrical charging system including the two magnetic induction plates: one of which is installed on the pad 1 and which is supplied with power by the battery 22, and the other 47 of which is installed on the drone 2. When the drone 2 is located on the platform 4, as shown in FIGS. 5 and 6, these two magnetic induction plates interact so that the induction plate of the pad 1, supplied with power by the battery 22, acts in the conventional way on the induction plate 47 of the drone 2, so that the latter supplies the battery of the drone 2 with power.

The drone 2 is also equipped with an automatic guiding unit that is configured to automatically guide the drone 2 toward the pad 1 of the managing set 45. To do this, the guiding unit determines guiding orders, from data relating to a position to be reached (GPS coordinates of the pad 1 or position of the positioning indicator 20 on the pad 1 in particular), and it transmits these guiding orders to conventional pieces of equipment of the drone which are intended to control its flight (motor, propellers, etc.). The guidance of the drone 2 (for example from its position in FIG. 1 with respect to the pad 1) to its final position in FIGS. 5 and 6 is carried out as follows: Initially, the guiding unit guides the drone 2 as close as possible to the pad 1 using the GPS coordinates of the pad 1 (which are transmitted thereto) and its own GPS coordinates which it determines using the positioning unit 48. Then, once possible, the video camera 46 of the drone 2 identifies the target 21 of the positioning indicator 20 on the pad 1, and the drone 2 determines the position of this target 21 and directs itself toward the latter in order to land on the platform 4, using the guiding unit. No intervention by the control center is therefore required to land the drone 2 on the pad 1. Nevertheless, an operator may intervene if needs be. In particular, he may take control of the drone 2 and direct it manually, or send it the GPS coordinates of another pad 1 in order to direct the drone toward this other pad 1.

Such a drone 2, which is therefore autonomous, may especially be used to carry out a visual inspection, for example, of the top of the fuselage of an aircraft in an airport; of a security zone of the airport; of a dangerous military zone; of a chemical warehouse; of vulnerable zones of a company, etc. As for the pad 1, it especially has the aim of docking a drone 2 in a secure zone, recharging the batteries of a docked drone 2, and delivering data on pieces of equipment of the drone 2 and/or of the pad 1.

More generally, the pad 1 is used to exchange data with the drone 2 and/or an operator of the control center 10. The data transmission system 5 is especially able to deliver the following data: the states of the batteries of the drone 2 and of the pad 1; the availability of the video camera 46 (video, calibration, infrared, etc.) of the drone 2; the state of the one or more motors of the drone 2; the availability of the pad 1; and the states of other pieces of equipment associated with the drone 2 and the pad 1.

To do this, each drone 2 includes, as schematically shown in FIG. 3, a data transmission unit 49 provided with an antenna 55 that interacts (emission/reception) with the data transmission unit 11 installed on the pad 1 and provided with the antenna 12, in order to allow them to communicate together, as illustrated by a symbol 56 (representing electromagnetic waves).

Moreover, for communication within the managing system 45, each drone 2 also includes, as also schematically shown in FIG. 3, a data transmission unit 57 provided with an antenna 58 that interacts (by emission/reception) with a data transmission unit 51 provided with an antenna 52, which is installed in the control center 10, in order to allow them to communicate together, as illustrated by a symbol 53 (representing electromagnetic waves).

The communication within the managing system 45 from the pad 1 may include: transmitting data from the pad 1 to the control center 10, for example at least one of the following data: the state of charge of the battery of the pad 1, the availability of the pad 1, and/or the state of at least one piece of equipment mounted on the pad 1 (bird scaring device, meteorological unit, solar panel, etc.); transmitting data from the control center 10 to the pad 1, for example at least one of the following data: a check request to the pad 1, and/or commands to pieces of equipment of the pad 1, such as the bird scaring device for example; transmitting data from the pad 1 to a drone 2, for example an order to stop a motor of the drone 2; and/or transmitting data from the drone 2 to the pad 1.

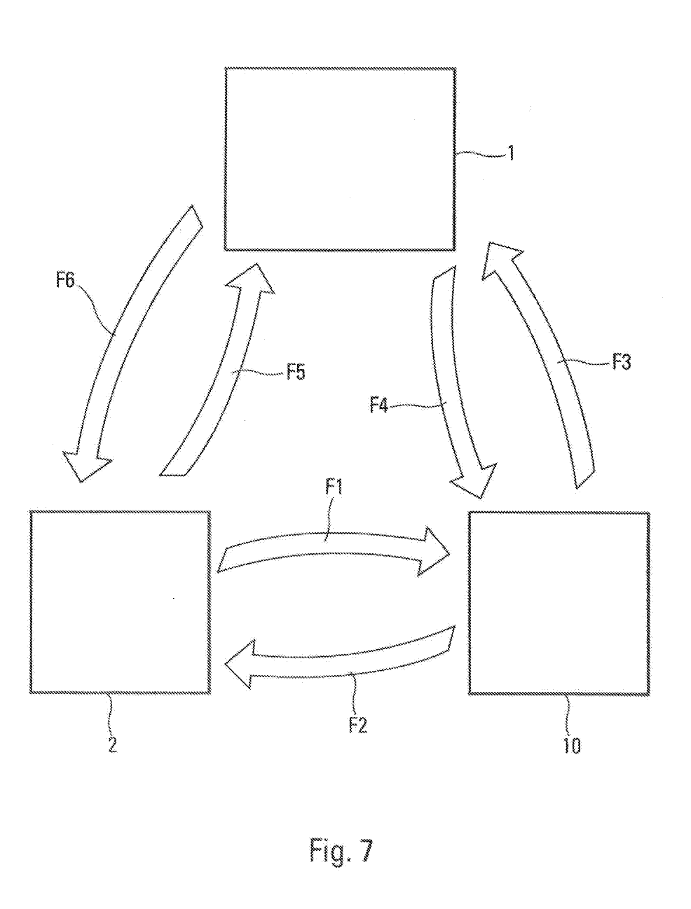

By way of illustration, the operation of the managing system 45, such as described above, may in one particular example involve the following events from E1 to E7, which may occur in any logical and desirably sequence:
E1: an operator (of the drone 2) installed in the control center 10 makes a state request to the drone 2, as illustrated by an arrow F2 in FIG. 7.
E2: data, especially on the battery level of the drone 2, the state of its memory card and of the video camera, are sent from the drone 2 to the operator of the control center 10, as illustrated by an arrow F1 in FIG. 7.
E3: the operator decides whether the drone 2 may be activated. This decision may optionally be made, automatically, by a central unit on the basis of thresholds to be exceeded or not be exceeded. For example, the drone 2 may be configured to take off only if its battery is charged to at least 75% and/or if its memory card is less than 50% full (transmission of a warning message). The operator remotely activates the mission of the drone 2, as illustrated by the arrow F2.
E4: the drone 2 takes off in order to carry out its mission. The drone 2 is controlled by the operator or it follows a program, as illustrated by the arrow F1.
E5: at any moment, the state of the pad 1 may be checked by the operator of the control center 10, as illustrated by an arrow F3. The pad 1 sends data for example regarding the level of its battery, its availability, and the operability of its various pieces of equipment (solar panel, induction plate, etc.), as illustrated by an arrow F4.
E6: at the end of its mission, the drone 2 is directed toward a pad 1 that is available and ready to dock it. The drone 2 directs itself toward the available pad 1 by virtue of the GPS coordinates of the pad 1. The drone 2 identifies (via the video camera 46) the position of the target 21 of the positioning indicator 20 on the pad 1 (arrow F5), in order to correctly land on the platform 4.
E7: when the two induction plates of the electrical charging system have made contact, the one or more batteries of the drone 2 are recharged (arrow F6). The end of the mission of the drone 2 is then reached.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1-14. (canceled)

15. A drone pad comprising:
a structure configured to be mounted on a base and having a platform for a drone;
a wireless data transmission system including a first data transmission unit configured to communicate with a control center and a second data transmission unit configured to communicate with a drone; and
a central unit linked to said data transmission system and having a computing unit configured to compute at least one takeoff path or one landing path of the drone.

16. The pad according to claim 1, further comprising a data generation unit linked to the central unit and configured to generate data relating to the pad, wherein at least a portion of the data being transmitted to the control center via the first data transmission unit.

17. The pad according to claim 1, further comprising an electrical charging system configured to charge a battery of the drone located on the platform, wherein the electrical charging system includes an electrical induction plate supplied with power by an electrical battery.

18. The pad according to claim 1, further comprising a positioning unit forming part of a satellite-based positioning system.

19. The pad according to claim 1, further comprising at least one solar panel mounted on the structure.

20. The pad according to claim 1, further comprising at least one meteorological unit mounted on the structure.

21. The pad according to claim 1, further comprising at least one battery and at least one unit for determining the state of the at least one battery.

22. The pad according to claim 1, further comprising a positioning indicator.

23. The pad according to claim 1, further comprising a bird scaring device.

24. The pad according to claim 1, further comprising a data generation unit configured to generate data relating to a drone.

25. A set for managing a pad comprising at least one pad according to claim 1 and a control center having an interacting data transmission unit, wherein the pad is linked via the first data transmission unit of the data transmission system to said control center via the interacting data transmission unit.

26. A system for managing at least one drone comprising a managing set according to claim 25, and at least one drone.

27. The system according to claim 26, wherein the drone comprising a guiding unit configured to automatically guide the drone toward the pad of the managing set.

28. The system according to claim 26, wherein the drone comprises a battery and an induction plate that is configured to recharge the battery, wherein the battery is inductively coupled to the induction plate of a pad of the managing set when the drone is located on the platform of this pad.

29. A method for transmitting data between a drone, a pad and a control unit using a system for managing at least one drone, the method comprising:
transmitting data from the pad to the control center, wherein the data being at least one member of the group including an availability of the pad, a charge state for a battery of the pad, and an operational state of an equipment mounted on the pad;
transmitting data from the control center to the pad, wherein the date includes a check request to the pad;
transmitting data from the pad to a drone, wherein the data includes an order to stop a motor of the drone; and
transmitting data from the drone to the pad.
